(19) United States
(12) Patent Application Publication
(10) Pub. No.: US 2004/0140985 A1
(43) Pub. Date: Jul. 22, 2004

(54) Apparatus for accelerating electro-optical response of the display

(75) Inventor: Ming-Jiun Liaw, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/636,539

(22) Filed: Aug. 8, 2003

(30) Foreign Application Priority Data
Jan. 20, 2003 (TW) 092101181

(51) Int. Cl. G09G 5/10

(52) U.S. Cl. 345/690

(57) ABSTRACT

An apparatus for accelerating electro-optical response of the display selects one of given internal or external driving voltages to overdrive gray levels transitions from other levels to neighboring darkest or brightest levels. A select controller is settled in the digital-to-analog-converter of a data driver to select internal or external given multi-reference voltages. It can accelerate electro-optical response of liquid crystals by the way of overdrive and resolve the failure to conventional overdrive of the highest and lowest gray level code, achieving the goal for increasing the electro-optical response of liquid crystal display.

### BACKGROUND OF THE INVENTION

1. Field of the Invention

The present invention relates to a device that could accelerate the electro-optical response and a method for setting multi-reference-voltage in digital-to-analog-converter of data driver to achieve overdrive of liquid crystal display.

2. Description of the Related Art

Conventionally, liquid crystal displays (LCDs) response slowly to external driving voltages. Although some inventions were disclosed to accelerate response of nematic liquid crystals, but the proposed methods still have obvious vision defects. Among these methods, the switching speed between fully-on and fully-off is high enough. But for middle gray level transitions, the speed is still insufficient. Another approach is developing new fast-response liquid crystal materials, but it costs too much. Thus, a new method to improve the electro-optical response of LCDs is still strongly desired. The conventional technique of overdrive referring to FIG. 1 shows the basic concept of accelerating response time of LCDs. If a pixel's present gray level source code, Gn, is not the same as its previous gray level code, Gn−1 [(n−1)th frame], it means the brightness of the pixel is supposed to be changed. If gray level source code Gn is directly transmitted to data driver for driving an LCD, the brightness variation curve is shown as the second curve B of FIG. 1. Due to the slow response of liquid crystal molecules, the pixel can't reach the target brightness within a frame-time. In order to accelerate the response time of liquid crystal display, in the conventional methods, the gray level Gn is converted to higher gray level code Gn′ on purpose and transmitted into data driver; then the response of LC follows the third curve C, reaching the target brightness just at the end of the frame. When the next gray level code of the next frame [(n+1)th frame] is the same as Gn, it means the brightness of the pixel should be kept the same; therefore, overdrive is unnecessary. In this case, all to do is transmit the present gray level source code Gn into data driver without any modification.

The function blocks of a conventional method accelerating response of LCDs is shown in FIG. 2. The gray level source code Gn of the present frame is stored into memory 203 as well as transmitted to a data modifier 205. The gray level source code Gn−1, stored in the memory 203, of the previous frame is also transmitted into data modifier 205. And then, wherein the judgment is conducted about whether overdrive is necessary or not. If data is different from that of the previous frame, the data modifier 205 read overdrive look-up table to enlarge voltage potential between LC cells to achieve overdrive purpose. In this case, a new gray level code Gn′ is generated and then converted into the driving voltage/electric current by data driver 207 and then sent to the panel.

FIG. 3 illustrates a digital-to-analog-converter of N-bit data driver used in the conventional technique. The data driver receives multi-bit (for example, N) digital image data, and several positive/negative polarity of reference-voltages (VG1, VG2, . . . , VGm). A series of design-in resistors generate 2^{N} analog voltages which correspond to 2^{N} digital image codes and are connected to the selector 301. According to the input digital image code, an analog-voltage will be select from the 2^{N} analog voltages by the selector 301 and outputted to the panel through the buffer 303.

In conventional technique, the overdrive is achieved by changing the image's digital codes to enlarge voltage potential between LC cells. Thus, the shortcoming of the conventional method using N-bit data drivers is unable to overdrive the transitions from any gray level to the darkest level marked as code zero or the brightest level marked as code 2^{N}−1.

To overcome the drawback, one possible approach is to use a more-than-N-bit data driver to reach transitions from any gray level to zero or 2^{N}−1 by code mapping. The drawback of the approach is that the die size of the kind of more-than N-bit data driver is almost two times larger than N-bit data driver, meaning that the cost is huge.

### SUMMARY OF THE INVENTION

The invention is a device with a major goal of accelerating the electro-optical response of display by giving at least two internal or external reference-voltages to the darkest and the brightest gray levels of a data driver. The invention not only accelerates electro-optical response of LCDs by overdrive but also compensates the drawback of the convention overdrive technique that is unable to overdrive transitions from other gray levels to the highest and lowest gray levels.

The invention features a data modifier that will not only modify input image data but also will generate at least one overdrive control signal. The overdrive control signal is used to determine one of the at least two internal/external driving voltages for the highest gray level of the data driver. Moreover, the overdrive control signal is also used to determine one of the at least two internal/external driving voltages for the darkest gray level of the data driver.

These and other objectives of the present invention will be described in further detail below.

It is to be understood that both the foregoing general description and the following detailed description are exemplary, and are intended to provide further explanation of the invention as claimed.

### BRIEF DESCRIPTION OF THE DRAWINGS

The invention will be described in relation to the drawings, whereon FIG. 1 illustrates a basic principle of accelerating electro-optical response of LCDs of the prior art;

FIG. 2 illustrates a schematic block diagram of accelerating electro-optical response of LCDs of the prior art;

FIG. 3 illustrates a schematic block diagram of a digital-to-analog-converter of a conventional data driver used in the prior art;

FIG. 4 illustrates a schematic block diagram of a digital-to-analog-converter of a data driver for a device that accelerates electro-optical response of display according to the first embodiment of the present invention;

FIG. 5 illustrates a schematic block diagram of a system that accelerates electro-optical response of display according to the present invention FIG. 6 illustrates a schematic block diagram of a data driver for a device that accelerates electro-optical response of display according to the first embodiment of the present invention;

FIG. 7 illustrates a schematic block diagram a data driver for a device that accelerates electro-optical response of display according to the second embodiment of the present invention;

FIG. 8 illustrates a schematic block diagram of a digital to analog converter of a data driver for a device that accelerates electro-optical response of display according to the second embodiment of the present invention;

FIG. 9 illustrates a schematic block diagram of a digital to analog converter of a data driver for a device that accelerates electro-optical response of display according to the third embodiment of the present invention;

FIG. 10 illustrates a schematic block diagram of a digital to analog converter of a data driver for a device that accelerates electro-optical response of display according to the fourth embodiment of the present invention.

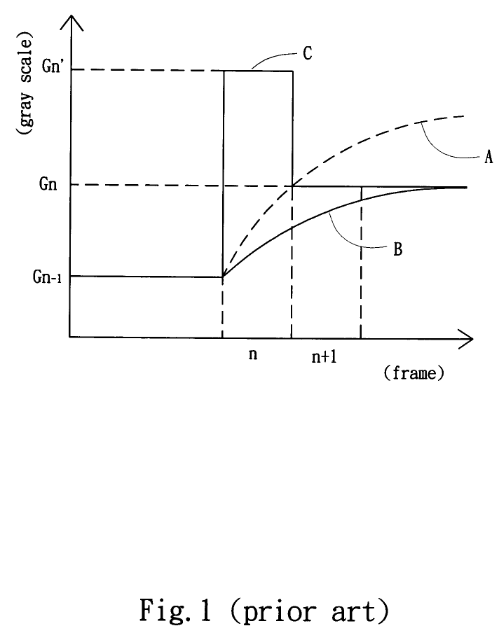

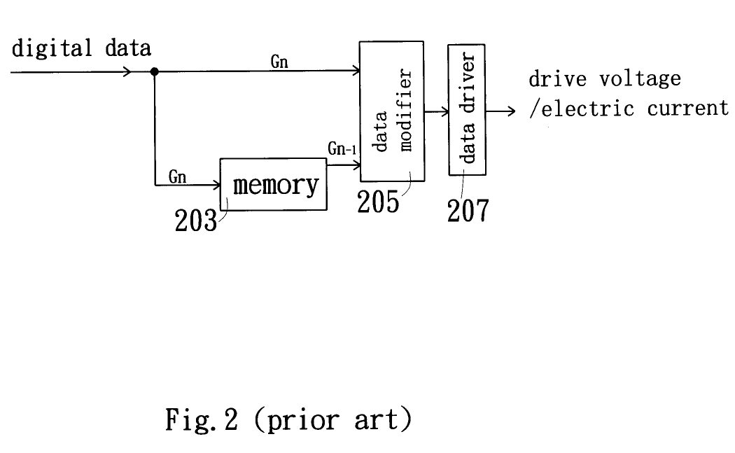

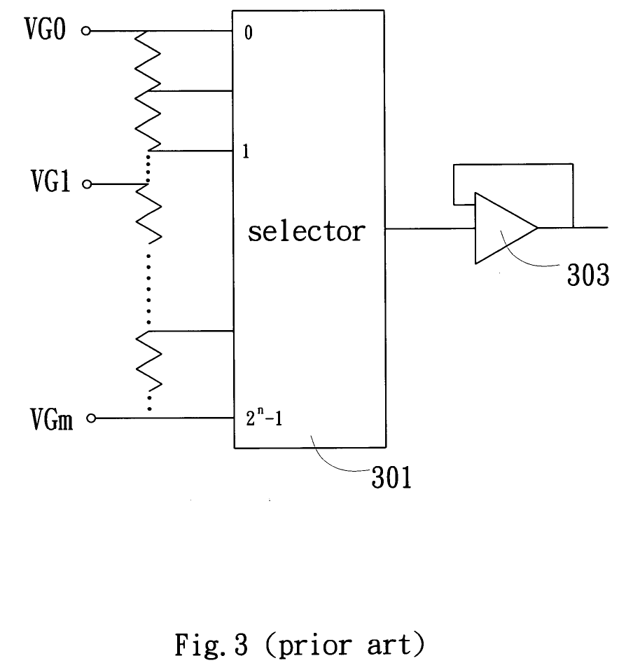

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

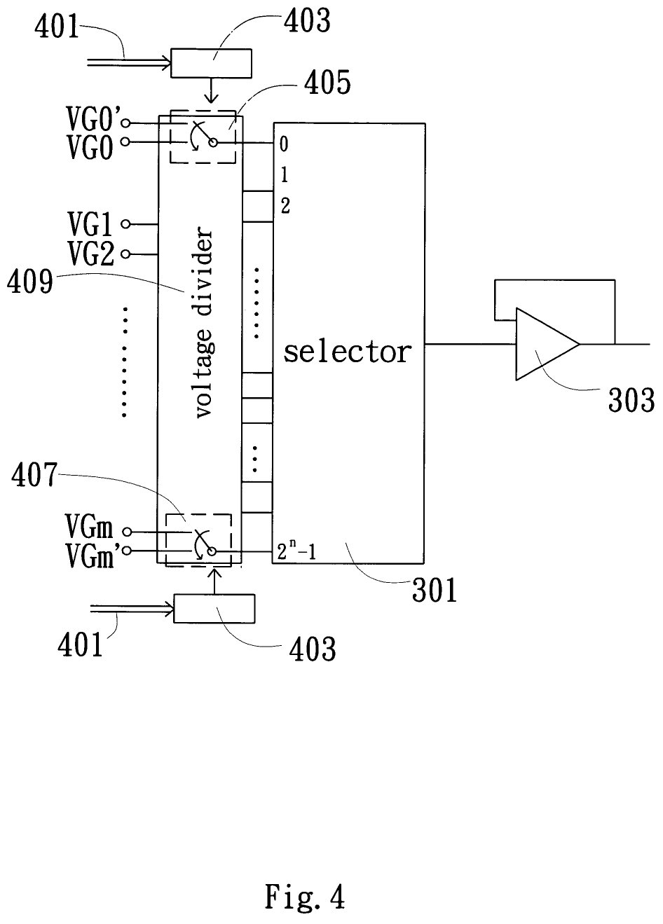

Please refer to FIG. 4, it is a first implement example illustration of digital-to-analog-converter for a device that accelerates the electro-optical response of display. The digital-to-analog-converter of the data driver receives N-bit digital data, connecting to positive/negative polarity by a plurality of reference voltages (VG1, VG2, . . . , VGm), and through them generating multi analog voltages to show digit signals on the display. A voltage divider 409 that contains a plurality of resistors and/or capacitors can generate more-than-2^{N} analog voltages to drive displays. In conventional technique, the transitions from other gray levels to zero or 2^{N}−1 (i.e. the darkest and the brightest gray level codes) can't be overdriven by using a N-bit data driver. Such as this invention in FIG. 4, for the highest and the lowest gray levels (code zero and 2^{N}−1, respectively), at least two driving voltages are given to each of the both codes by external driving circuits or by internal data driver. That means at least two driving signals can be selected by the brightest image code, 2^{N}−1. Also at least two driving signals can be selected by the darkest image code, 0. To see in the figure, the reference voltages of the darkest gray level are the first reference voltage VG0 and the second reference voltage VG0′, both are for the transitions from other gray levels to the lowest gray level; the reference voltages of the brightest level include the first reference voltage VGm and the second reference voltage VGm′, both are for the transitions from other gray levels to the highest gray level, 2^{N}−1. Furthermore, both the second reference voltages, VG0′ and VGm′, also can be used as the overdrive reference voltages for the transitions from.other gray levels to zero or to 2^{N}−1, respectively.

When image changes, the invention is going to compare pixel values between the present frame and the previous frame. For the pixel occurring gray level transition, its pixel values will be re-determined. The overdrive control signal 401 from the driving system described below in this invention, uses different voltage levels or electric currents to identify whether or not the overdrive reference voltage of the second reference voltage VG0′ of the darkest gray level code or VGm′ of the brightest gray level code will be selected. If needed, the overdrive control signal 401 is set to a specific level (e.g. high level or high electric current or positive electric current or low impedance), and the first switch 405 and the second switch 407 of select controller 403 to select the second reference voltage VG0′ of the darkest gray level code or VGm′ of the brightest gray level code. If overdrive is not necessary, the overdrive control signal 401 is set to an opposite level (e.g. low level or low electric current or negative electric current or high impedance) and the first switch 405 and the second switch 407 of select controller 403 to select the first reference voltage VG0 of the darkest gray level code or VGm of the brightest gray level code.

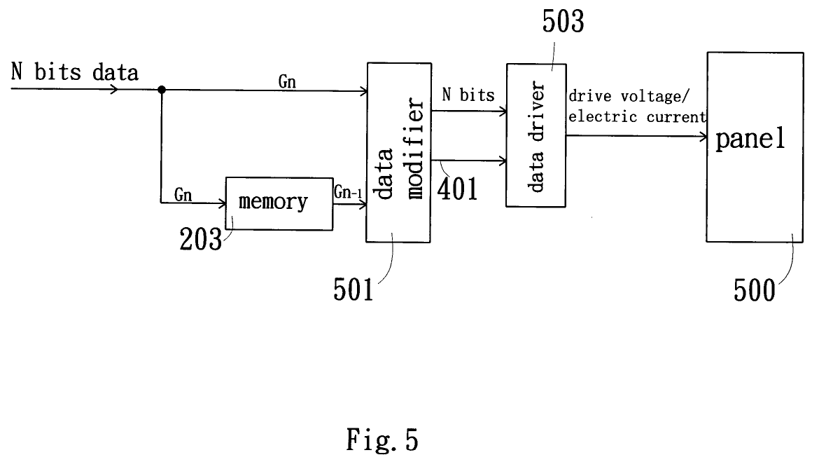

FIG. 5 is a circuit connection illustration for a device that accelerates the electro-optical response of a display. The system features receiving N-bit image information, then generating at least (N+1)-bit signal. In the (N+1)-bit signal, N-bits is image information and the other one is at least one bit signal 401 expressing whether overdrive is needed or not by the second reference voltages VG0′ of the darkest gray level code and VGm′ of the brightest gray level code, respectively.

The operation is as follows: receive N-bit gray level code of a frame. Moreover, transmit them to memory 203 and data modifier 501.

The memory 203 includes two sets of memory units, one is the first memory unit, it stores the data in the present frame, Gn, and the previous frame, Gn−1; and the other one is the second memory unit, it stores overdrive strategy that might be expressed as LUTs. The data modifier 501 reads gray level code Gn−1 of previous frame from the memory 203, and then comparing with the present image data to judge whether and where (what pixel) overdrive is necessary.

Case (1): For pixels without gray level variation, the input N-bit data is output by the data modifier 501; at the same time the overdrive control signal 401 will be settled by modifier 501 to a specific states (for example, low level or low electric current or negative electric current or high impedance) to represent overdrive for this pixel is unnecessary. And then the overdrive control signal 401 will be sent to the data driver 503.

In contrast, for the pixels whose gray levels need to be changed, the data modifier 501 re-determines the image code in order to enlarge voltage potential or current between two-opposite electrodes of the display and achieves overdrive according to look-up table or interpolation or both of them or numerical operation analysis. In such situation, two cases can be further distinguished:

Case (2): If the gray level transition isn't from other gray levels to the neighbor levels of the brightest or the darkest region (including exactly the brightest and darkest) or it is not necessary to overdrive the pixel via the overdrive reference voltages such like the second reference voltage VG0 or VGm′, the overdrive control signal 401 is set to the same specific state in case (1).

Case (3): If the gray level transition is from other gray levels to the neighboring levels of the brightest or darkest level (including exactly the brightest and darkest) and needs overdrive by the second reference voltage VG0 or VGm′, the overdrive control signal 401 is going to set to a state in contrast to the previous descriptions (for example, high level or high electric current or positive electric current or low impedance). Then, the modified N-bit image data and the overdrive control signal 401 will be sent to the data driver 503 whose first embodiment is going to described in FIG. 6 to drive panel 500.

FIG. 6 is the first example illustration of a data driver 503 for a device that accelerates the electro-optical response of display. The image data from the data modifier 501 is transmitted into data driver 503 (FIG. 5), and then is stored into the first register 601 and is hold in the first latch 603. At the same time, the overdrive control signal 401 is transmitted into the second register 602 and latched by the second latch. One of the data bits 611 is further transmitted to select controller 403 to judge the gray level transition is occurred close to or exactly at the darkest or the brightest gray levels. For the case of close to or exactly at the darkest level, the second reference voltage VG0′ will be selected; For the case of close to or exactly at the brightest level, the VGm′ will be selected. The selection is done by the select controller 403. When an overdrive by the second reference voltage VG0′ or VGm′ is needed, the first switch 405 and the second switch 407, as shown in FIG. 4, will select the second reference voltage VG0′ or VGm′ according to the combination result of the overdrive control signal 401 and one of the data bits 611. When VG0′ or VGm′ isn't need, the first reference voltage VG0 or the first reference voltage VGm will be selected. Finally, digital-to-analog-converter 400 outputs an analog driving voltage or current to buffer 607 and then drive the pixels in the displays.

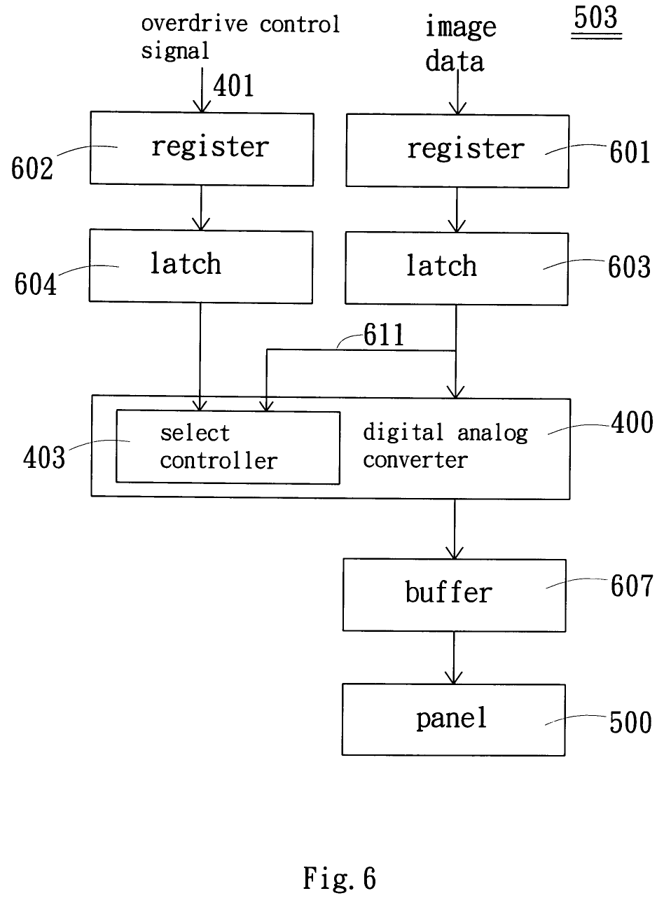

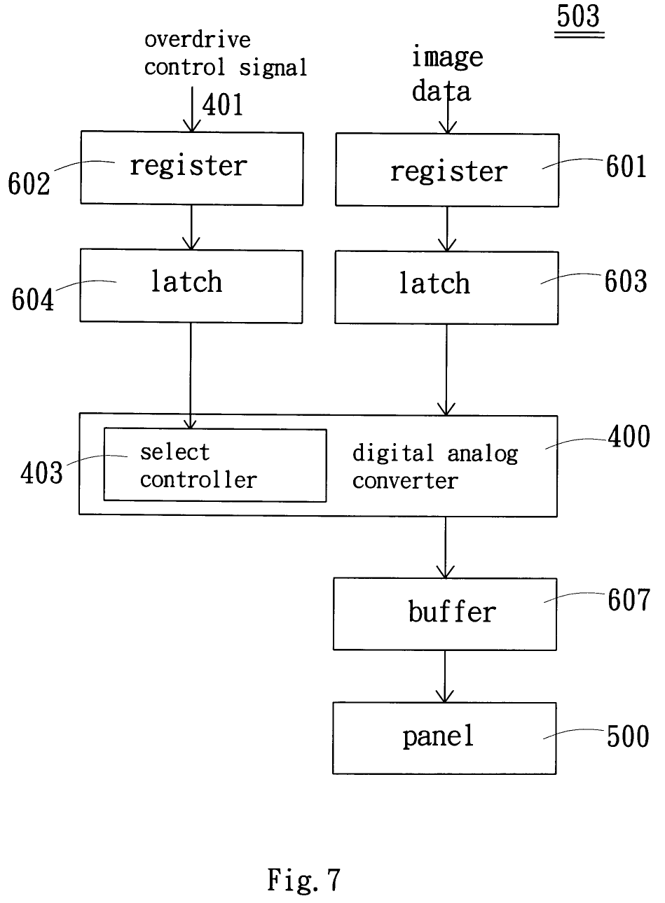

FIG. 7 is the second implement example illustration. The difference between the implement and the first one is that the first switch 405 and the second switch 407 as shown in FIG. 4 selects the second reference voltage VG0′ or VGm′ only according to the state of the overdrive control signal 401, not the combination result of the overdrive control signal 401 and one of the data bits 611.

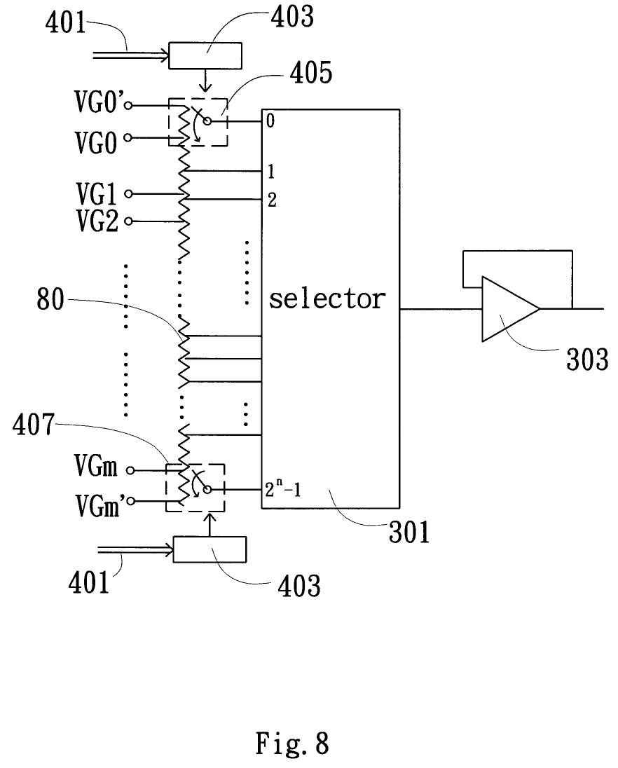

FIG. 8 is the second implement example illustration of digital-to-analog-converter of a data driver for a device that accelerates electro-optical response of display in this invention.

Its voltage-divided circuit is constructed by a plurality of resistors cooperated with a plurality of reference voltages.

Certainly, the highest and lowest gray level code in data driver, are also given at lest two driving voltages, individually. In FIG. 8, the first reference voltage VG0 and the second reference voltage VG0′ for the darkest gray level code (0) are connected by resistor. The first reference voltage VGm and the second reference voltage VGm′ for the brightest gray level code (2^{N}−1), are also connected by resistor. Nevertheless, the voltage of VG0 (or VG0′) can be generated by other methods, such as resistor-voltage-divider referring to the second-reference-voltage VG0′ (or the first-reference-voltage VG0), by capacitor-voltage-divider, by resistor or capacitor combinations, by step up or step down circuits. The voltage of VGm (or VGm′) also can be generated by the above-mentioned several methods.

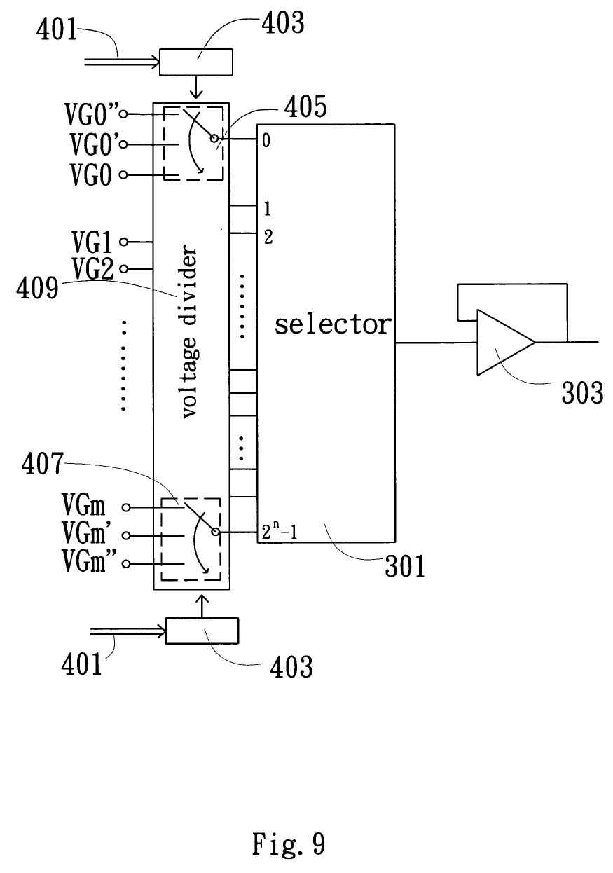

Refer to FIG. 9, the third implement example illustration of digital-to-analog-converter of a data driver for a device that accelerates electro-optical response of display. In this example, more than two driving voltages can be selected to overdrive the transitions from other gray levels to the neighboring levels of the darkest or brightest gray levels. Take 3 driving voltages as an example, the first driving voltage VG0, the second driving voltage VG0′, and third driving voltage VG0″ can be chosen for overdrive purpose. When select controller 403 receive the overdrive-control-signal 401, base on the swing of gray level changes, the controller will select a proper driving voltage from VG0, VG0′and VG0″ On principle, around the brightest gray level code ‘2^{N}−1’ also can have several driving voltages VGm, VGm′ and VGm″ to be selected for overdrive purpose.

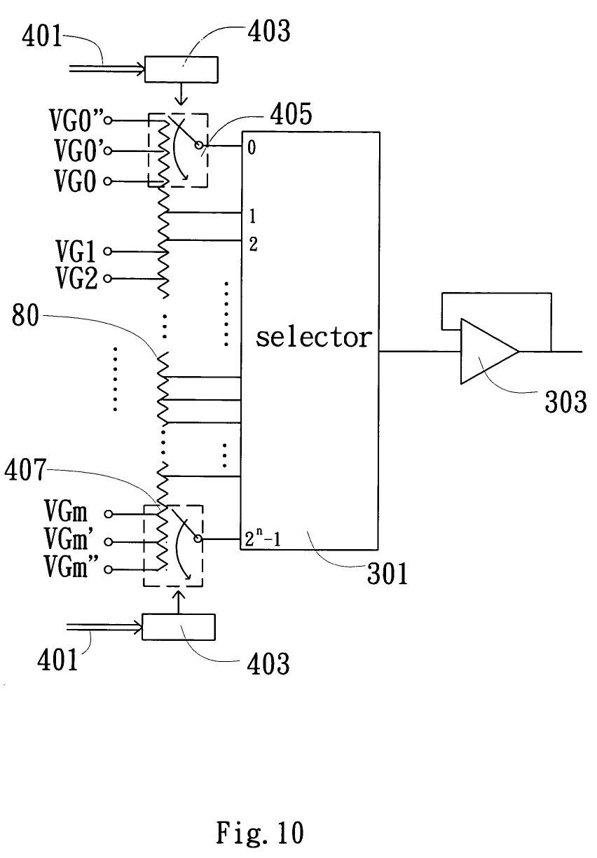

The fourth implement example illustration of a digital-to-analog-converter is shown in FIG. 10. The analog driving voltages are generated by a resistor-voltage-divider as shown in FIG. 9. The select controller 403 can select different overdrive voltages according to different states of the overdrive control signal 401.

Detail above-explanations are about a device that accelerates the electro-optical response of a display. The purpose of accelerating the electro-optical response of liquid crystals is achieved by way of generating a overdrive-control-signal to control a plurality of external or internal driving voltages corresponding to a specified gray level, darkest or brightest or both. To integrate mentions above, it shows the purpose and efficacy of this invention provided with advanced and value in industry. Meanwhile, it's a new and hither to unknown invention in current market. So apply for a patent base on patent law.

In accordance to the above mention, therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method and apparatus for accelerating electro-optical response of the display wherein it not only improve the electro-optical response of the display by the way of enlarging drive ability but also resolve the drawback of overdrive around the brightest and darkest gray level source code, comprising:
a data modifier receiving a plurality of bits of image data, and then generating modified multi-bit image data and an overdrive-control-signal; and
at least one data driver receiving the modified image data and overdrive-control-signal to generate various electric signals for driving the display.

2. The method and apparatus for accelerating electro-optical response of the display in accordance with claim 1, wherein the data driver has a digital-to-analog-converter.

3. The method and apparatus for accelerating electro-optical response of the display in accordance with claim 2, wherein the digital-to-analog-converter in the device connects a plurality of reference electric signals to generate more drive signals of display.

4. The method and apparatus for accelerating electro-optical response of the display in accordance with claim 3, wherein at least the darkest gray level source code of digital-to-analog-converter in this device has a plurality of driving signals to select.

5. The method and apparatus for accelerating electro-optical response of the display in accordance with claim 3, wherein at least the brightest gray level source code of digital-to-analog-converter in this device has a plurality of driving signals to select.

6. The method and apparatus for accelerating electro-optical response of the display in accordance with claim 3, wherein at least the darkest and the brightest gray level source code of digital-to-analog-converter in this device have a plurality of driving signals to select.

7. An apparatus for accelerating electro-optical response of the display wherein it not only increases driving signal differences by data driver to improve the electro-optical response of the display but also resolve the failure of overdrive around the brightest and darkest gray level source code, comprising:
a first memory unit that stores image data of the present frame and read image data of the previous frame at the same time;
a second memory unit that stores at least one overdrive strategy;
a data modifier that receives multi-bit image data and to continuously compares images between the present frame and the previous frame, and then generates modified multi-bit image data and at least one overdrive control signal; and
a data driver that receives image data and the at least one overdrive control signal from the data modifier, and then it can generate electric signals to drive the display.

8. The apparatus for accelerating electro-optical response of the display in accordance with claim 7, wherein the date driver further comprising:
an electric driving signal generation unit connecting to a plurality of reference electric signals and generating more electric signals than the number of gray levels expressed by image data;
an electric driving signal selector connecting to a plurality of electric driving signals generated by electric driving signal generating unit and connected with input image data;
a first switch connecting the a plurality of driving signals of the darkest gray level code;
a second switch connecting a plurality of driving signals of the brightest gray level code; and
a select controller connecting to the first switch and the second switch wherein it can select one of the plurality of the driving electric signals corresponding to the darkest and the brightest gray level codes, by the switch.

9. The apparatus for accelerating electro-optical response of the display in accordance with claim 8, wherein the select controller receives the overdrive control signal and connects the switch states between the first switch and second switch; therefore, controls the first and second switches in terms of the overdrive signal.

10. The apparatus for accelerating electro-optical response of the display in accordance with claim 8, wherein the select controller receives the overdrive control signal and connects the switch states between the first switch and second switch; then controls the first and second switches in terms of the combination state of the overdrive control signal and at least one bit image data.
